(19) United States
(12) Patent Application Publication
(10) Pub. No.: US 2026/0118686 A1
(43) Pub. Date: Apr. 30, 2026

(54) TEMPLE CONNECTION STRUCTURE AND HEAD-MOUNTED DISPLAY DEVICE

(71) Applicant: GOERTEK INC., Weifang (CN)

(72) Inventors: Xiongchun DU, Weifang (CN); Yaocheng LIU, Weifang (CN); Chao ZHANG, Weifang (CN); Xiangdong LAN, Weifang (CN); Chuanlong LI, Weifang (CN)

(21) Appl. No.: 19/433,554

(22) Filed: Dec. 26, 2025

Related U.S. Application Data
(63) Continuation of application No. PCT/CN2024/137125, filed on Dec. 5, 2024.

(30) Foreign Application Priority Data
Jun. 26, 2024 (CN) 202410840797.X

(51) Int. Cl. G02B 27/01; G02C 5/22

(52) U.S. Cl. CPC G02B 27/0176; G02C 5/2236; G02B 2027/0152; G02B 2027/0154; G02B 2027/0178

(57) ABSTRACT

The present application discloses a temple connection structure and a head-mounted display device. The temple connection structure is configured for connecting a temple and a frame, including: a first bracket and a second bracket rotatably connected to the first bracket, a movable member, and a first elastic member. The first bracket is configured to fix the frame, and the second bracket is configured to fix the temple. The movable member is movably installed at the first bracket and connected to the second bracket. The first elastic member is provided between the first bracket and the movable member, and detachably provided from the movable member. When the second bracket is folded inward from an open position, the elastic member is configured to separate from the movable member.

### CROSS-REFERENCE TO RELATED APPLICATIONS

This application is a continuation application of International Application No. PCT/CN2024/137125, filed on Dec. 5, 2024, which claims priority to Chinese Patent Application No. 202410840797.X, filed on Jun. 26, 2024. The disclosures of the above-mentioned applications are incorporated herein by reference in their entireties.

### TECHNICAL FIELD

The present application relates to the technical field of head-mounted device, and particularly to a temple connection structure and a head-mounted display device.

### BACKGROUND

Current head-mounted display devices, including but not limited to augmented reality (AR) glasses, virtual reality (VR) glasses, and mixed reality (MR) glasses, typically use a simple hinge structure for the connection between the temple and the frame. When worn by users with larger head circumferences, the temple tends to fold outwards, and the temple's grip on the user's head is weak, causing the device to easily slip forward.

### SUMMARY

The main purpose of the present application is to provide a temple connection structure and a head-mounted display device, aiming to improve the clamping force when the temples fold outwards, thereby enhancing the wearing stability of the head-mounted display device.

To achieve the above purpose, the present application proposes a temple connection structure for connecting a temple and a frame, including:
a first bracket and a second bracket rotatably connected to the first bracket, the first bracket is configured to fix the frame, and the second bracket is configured to fix the temple;
a movable member movably installed at the first bracket and connected to the second bracket; and
a first elastic member provided between the first bracket and the movable member, and detachably provided from the movable member,
wherein when the second bracket is folded inward from an open position, the elastic member is configured to separate from the movable member; and
when the second bracket is folded outward from the open position, both ends of the first elastic member is configured to abut against the movable member and the first bracket respectively, and the second bracket is configured to receive an elastic force transmitted through the movable member from the elastic member, thereby providing a clamping force for the temple.

In an embodiment, the movable member includes a connect rod and a first slide member and a second slide member connected via the connect rod; the first bracket includes a first slide groove and a second slide groove; the first slide member is slidably connected to the first slide groove, and the second slide member is slidably connected to the second slide groove; the second bracket is connected to the first slide member, and the first elastic member is provided between the first bracket and the second slide member.

In an embodiment, the first bracket includes a limit protrusion, and the first elastic member is configured to abut against the limit protrusion in the open position;
when the second bracket is folded outward from the open position, the second bracket is configured to drive the second slide member to press against the first elastic member away from the limit protrusion; and
when the second bracket is folded inward from the open position, the second bracket is configured to drive the second slide member away from the first elastic member.

In an embodiment, the temple connection structure further includes an installation member, the installation member is provided between the first elastic member and the second slide member, the first elastic member is installed at the installation member and the installation member is configured to abut against the limit protrusion in the open position.

In an embodiment, a cross-section of the installation member is arc-shaped cross-section protruding away from the second slide member, and the second slide member is detachably engaged with the installation member in the open position.

In an embodiment, an installation protrusion is provided to protrude from the installation member, and the first elastic member is sleeved on the installation protrusion.

In an embodiment, the first slide groove is arc-shaped groove, and the second slide groove is linear-typed groove.

In an embodiment, the temple connection structure further includes a second elastic member, the second elastic member is connected between the movable member and the second bracket, and an elastic deformation of the second elastic member is configured to first increase and then decrease during a process of the bracket switching from a folded position to the open position.

In an embodiment, a minimum distance between the first slide groove and the second slide groove is a distance between a first position of the first slide groove and a second position of the second slide groove, and a length of the connect rod is greater than the minimum distance;
the first position is provided between both ends of the first slide groove, and the first slide member is respectively provided at both sides of the first position in the open position and the folded position; and
the second position is provided at one end of the second slide groove, and the other end of the second slide groove is configured to extend away from the first position, and the second elastic member is configured to abut against a side of the slide member opposite to the second position.

In an embodiment, a length direction of the second slide groove is parallel to an axial direction of the first elastic member, and the second slide groove is opposite to the first elastic member in a width direction.

In an embodiment, the length direction of the second slide groove is parallel to an axial direction of the second elastic member, and the second slide groove is opposite to the second elastic member in the width direction.

In an embodiment, the second bracket is provided with a slide protrusion and is rotatably connected to the first slide member, and the slide protrusion is configured to avoid the first slide member and slidably connected to the first slide groove, to cause a center of a circle of the first slide groove to be a rotation center of the second bracket relative to the first bracket.

In an embodiment, the slide protrusion is configured as an arc shape adapted to the first slide groove, an end of the first slide groove is provided with an avoidance notch, and a portion of the slide protrusion is configured to extend out from the avoidance notch when the second bracket is in a folded position.

In an embodiment, the second bracket includes two support arms spaced apart, the second bracket is rotatably connected to the first slide member by the support arm, the two support arms are configured to extend into the first bracket, and the slide protrusion is provided at opposite sides of the two support arms; the first bracket is correspondingly provided with two first slide grooves, and one slide protrusion is correspondingly slidably connected to the first slide groove.

In an embodiment, two first slide members, two connect rods, two first slide grooves, and two second slide grooves are correspondingly provided; one first slide member is correspondingly connected to one first slide groove; both ends of the second slide member are respectively connected to one second slide groove; one connect rod is correspondingly connected to one end of one first slide member and the second slide member; two first slide members are spaced apart to allow an electrical connector between the temple and the frame to pass through.

In an embodiment, the first slide member and/or the second slide member are correspondingly rotatably connected to an end of the connect rod.

The present application further proposes a head-mounted display device, including a frame, temples, and the aforementioned temple connection structure, and the temples are installed on the frame via the temple connection structure.

In the technical solution of the present application, when a user with a large head circumference wears a head-mounted display device, the temple folds outward compared to the open state, and the second bracket also folds outward from the open position accordingly. This allows the movable member to be supported by the elastic force of the first elastic member. Simultaneously, the second bracket acts on the movable member, and thus the second support bracket can also be subjected to the elastic force from the first elastic member transmitted by the movable member. Therefore, the elastic force of the first elastic member can provide additional clamping force to the temples, thereby increasing the clamping force of the temples on the user's head and improving the wearing stability of the head-mounted display device.

### BRIEF DESCRIPTION OF THE DRAWINGS

In order to explain the embodiments of the present application or the technical solutions in the existing technology more clearly, the accompanying drawings needed to be used in the description of the embodiments or the existing technology will be briefly introduced below. Obviously, the accompanying drawings in the following description are only some embodiments of the present application, other accompanying drawings can be obtained based on the provided accompanying drawings without exerting creative efforts for those skilled in the art.

FIG. 1 is an assembly schematic structural view of a temple connection structure being assembled within a frame and a temple according to the present application.

FIG. 2 is a cross-sectional view of a temple connection structure in an open position according to an embodiment of the present application.

FIG. 3 is an exploded schematic structural view of a temple connection structure according to an embodiment of the present application.

FIG. 4 is an assembly schematic structural view of a movable member and a second bracket of a temple connection structure according to an embodiment of the present application.

FIG. 5 is a schematic structural view of a temple connection structure in an open position according to an embodiment of the present application.

FIG. 6 is a schematic structural view of the temple connection structure in FIG. 2 from another perspective.

FIG. 7 is a schematic structural view of a temple connection structure in a maximum elastic position during inward folding according to an embodiment of the present application.

FIG. 8 is a schematic structural view of a temple connection structure in a folded position according to an embodiment of the present application.

FIG. 9 is a schematic structural view of a temple connection structure in a maximum outward flare position according to an embodiment of the present application.

The realization of the purpose, functional features and advantages of the present application will be further described in conjunction with the embodiments and with reference to the accompanying drawings.

### DETAILED DESCRIPTION OF THE EMBODIMENTS

The technical solutions in the embodiments according to the present application will be clearly and completely described below in conjunction with the accompanying drawings in the embodiments according to the present application, and it is clear that the described embodiments are only a part of the embodiments according to the present application, and not all of the embodiments. Based on the embodiments in the present application, all other embodiments obtained by those skilled in the art without making creative labor fall within the scope of the present application.

It should be noted that if there are directional instructions (such as up, down, left, right, front, back or the like) involved in the embodiments of the present application, the directional indications are only used to explain the relative positional relationship, movement and so on between various components in a specific posture (as shown in the accompanying drawings). If the specific posture changes, the directional indication will also change accordingly.

In addition, in the present application, if there are descriptions involving “first”, “second” or the like, the descriptions of “first”, “second” or the like are only for descriptive purposes and cannot be understood as indicating or implying the relative importance or implicitly indicating the quantity of the technical features indicated. Therefore, features defined as “first” and “second” may explicitly or implicitly include at least one of these features. In addition, the meaning of “and/or” or “and/or” appearing in the entire text includes three parallel solutions, taking “A and/or B” as an example, it includes solution A, or solution B, or a solution that satisfies both A and B at the same time. In addition, the technical solutions of various embodiments can be combined with each other, but it is based on that those skilled in the art can realize. When the combination of technical solutions is contradictory or cannot be realized, it should be considered that such combination of technical solutions does not exist and is not within the protection scope claimed by the present application.

The present application proposes a temple connection structure. Understandably, this temple connection structure is suitable for connecting the frame of various types of eyeglasses and temple of various types of eyeglasses. The following embodiment uses a head-mounted display device as an example, but the application of the temple connection structure of the present application is not limited to head-mounted display devices.

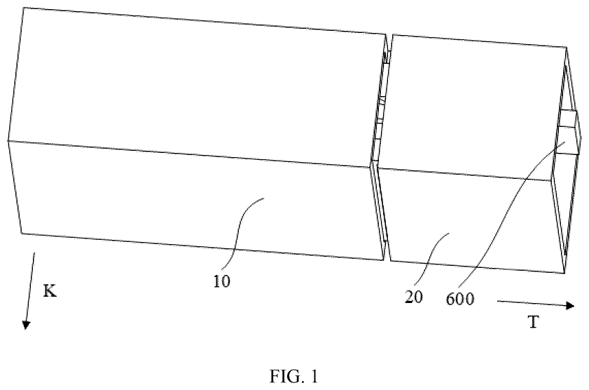

Referring to FIG. 1 to FIG. 3, in an embodiment of the present application, the temple connection structure is used to connect the temple 20 and the frame 10, the extension direction of the frame 10 is K, and the extension direction of the temple 20 is T. The temple connection structure includes a first bracket 100, a second bracket 200, a movable member 300 and a first elastic member 410.

The second bracket 200 is rotatably connected to the first bracket 100, the first bracket 100 is configured to fix the frame 10, and the second bracket 200 is configured to fix the temple 20.

The movable member 300 is movably installed at the first bracket 100 and connected to the second bracket 200.

The first elastic member 410 is provided between the first bracket 100 and the movable member 300, and detachably provided from the movable member 300.

When the second bracket 200 is folded inward from an open position, the elastic member 410 is configured to separate from the movable member 300.

When the second bracket 200 is folded outward from the open position, both ends of the first elastic member 410 is configured to abut against the movable member 300 and the first bracket 100 respectively, and the second bracket 200 is configured to receive an elastic force transmitted through the movable member 300 from the elastic member 410, thereby providing a clamping force for the temple 20.

Understandably, the abutment of the first elastic member 410 against the movable member 300 and the first bracket 100 can be a direct abutment, an indirect abutment, or an interlocking connection, allowing the first elastic member 410 to transmit elastic force to the movable member 300 and the first bracket 100.

In the technical solution of the present application, the second bracket 200 has a folded position and an open position. The temple 20 is fixedly connected to the second bracket 200. When the second bracket 200 is in the folded position, the temple 20 is in a folded state and overlaps with the frame 10. When the second bracket 200 is in the open position, the temple 20 is in an open state, and the temple 20 and the frame 10 are approximately at a 90-degree angle.

When a user with a large head circumference wears a head-mounted display device, the temple 20 folds outward compared to the open state, and the second bracket 200 also folds outward from the open position accordingly. This allows the movable member 300 to be supported by the elastic force of the first elastic member 410. Simultaneously, the second bracket 200 acts on the movable member 300, and thus the second support bracket can also be subjected to the elastic force from the first elastic member 410 transmitted by the movable member 300. Therefore, the elastic force of the first elastic member 410 can provide additional clamping force to the temples 20, thereby increasing the clamping force of the temples 20 on the user's head and improving the wearing stability of the head-mounted display device.

Furthermore, in the open position, the first elastic member 410 can be in a natural state. When the second bracket 200 folds outward from the open position, by acting on the movable member 300, causing the elastic deformation of the first elastic member 410 to gradually increase, and the clamping force of the temples 20 to gradually increase accordingly. In the open position, the first elastic member 410 can also be in an elastically deformed state. Thus, when the outward folding amplitude of the second bracket 200 is small, the second bracket 200 can receive a relatively large elastic force from the first elastic member 410 by the cooperation with the movable member 300, thereby giving the temples 20 a sufficiently large clamping force.

Understandably, given that the first elastic member 410 can provide clamping force when the temple 20 is folded outwards, requiring the first elastic member 410 to also provide assistance when the temple 20 is folded inwards would increase the design complexity of the temple connection structure and make the first elastic member 410 prone to failure. In the technical solution of the present application, when the user folds the temple 20, the first elastic member 410 disengages from the movable member 300, and the elastic force of the first elastic member 410 can no longer be transmitted to the second bracket 200, thus not interfering with the inward folding of the second bracket 200, which helps ensure the smoothness of the temple 20's folding.

Specifically, the first elastic member 410 can be a tension spring or a compression spring, or can be an elastic body such as a leaf spring, disc spring, torsion spring, variable diameter spring, or air compression spring.

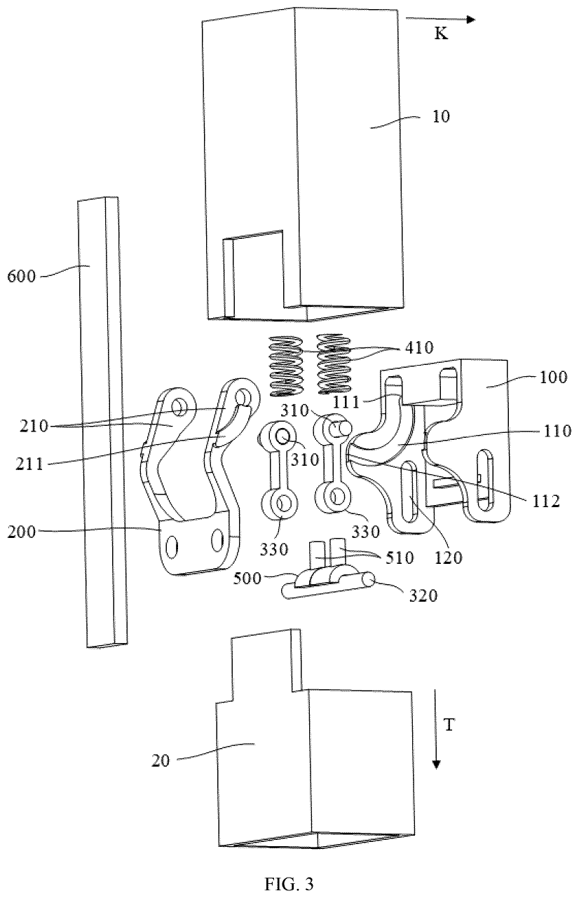

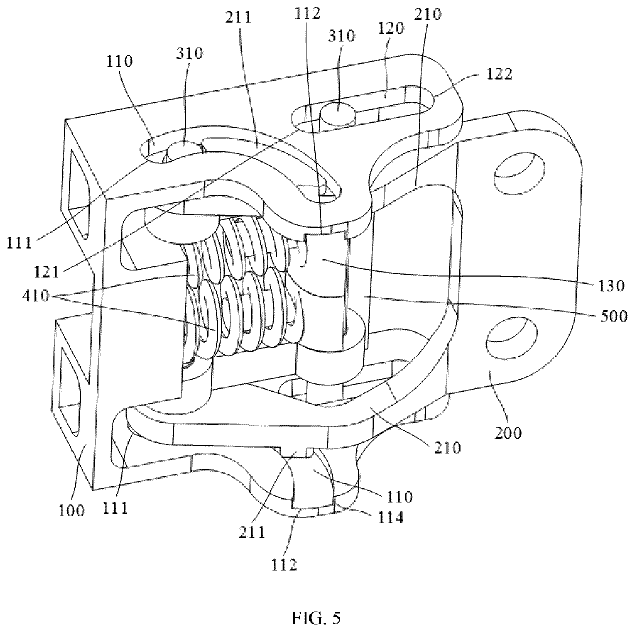

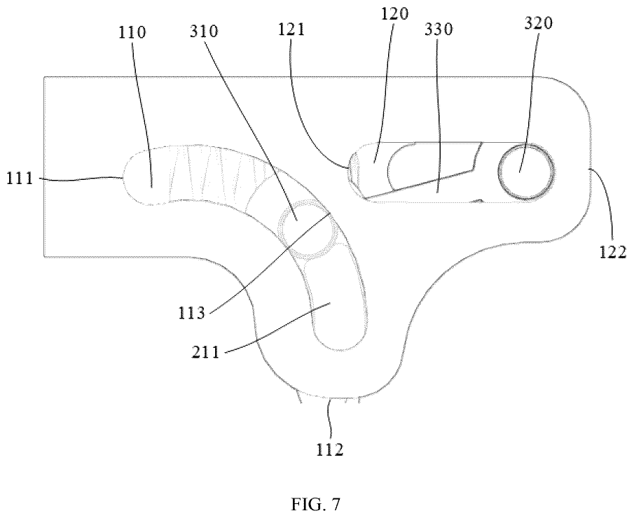

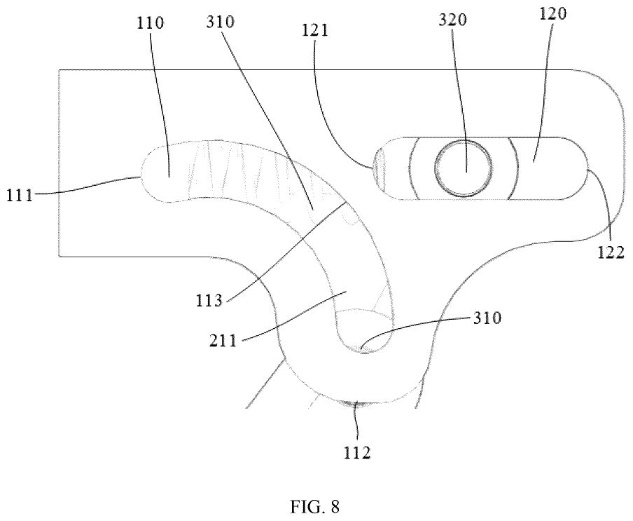

Further, as shown in FIG. 3 to FIG. 5, in this embodiment, the movable member 300 includes a connect rod 330 and a first slide member 310 and a second slide member 320 connected via the connect rod 330; the first bracket 100 includes a first slide groove 110 and a second slide groove 120; the first slide member 310 is slidably connected to the first slide groove 110, and the second slide member 320 is slidably connected to the second slide groove 120; the second bracket 200 is connected to the first slide member 310, and the first elastic member 410 is provided between the first bracket 100 and the second slide member 320. It should be noted that in this embodiment, the first slide groove 110 is configured as a blind groove as shown in FIG. 3. The arc-shaped through holes on the first bracket 100 in FIG. 5 to FIG. 8 are all for clearly showing the cooperation between the first slide member 310 and other related structures and the first slide groove 110; these arc-shaped through holes are not inherent structures on the first bracket 100.

Thus, when the second bracket 200 drives the first slide member 310 to move along the first slide groove 110, it can drive the second slide member 320 to slide within the second slide groove 120 via the connect rod 330. When the temple 20 is folded outward, the second slide member 320 slides within the second slide groove 120 and is able to act on the first elastic member 410, the elastic force of the first elastic member 410 is transmitted sequentially to the second bracket 200 via the second slide member 320, the connect rod 330, and the first slide member 310, thereby providing clamping force for the temple 20. That is, in this embodiment, the second bracket 200 acts directly on the first slide member 310, and the first elastic member 410 acts directly on the second slide member 320, and the force of the first elastic member 410 is indirectly transmitted inside the movable member 300 via the connect rod 330. In this way, it allows for a more dispersed distribution of forces on the movable member 300, which is beneficial to ensuring the structural stability of the movable member 300. Furthermore, the first slide member 310 and the second slide member 320 can respectively take into account the positions of the second bracket 200 and the first elastic member 410. The displacement between the first slide member 310 and the second slide member 320 caused by the rotation of the second bracket 200 can be compensated by the connect rod 330. Certainly, in other embodiments, the movable member 300 may adopt other structural forms. Provided that the structural strength of the movable member 300 meets the requirements, the force exerted by the second bracket 200 on the movable member 300 and the force exerted by the first elastic member 410 on the movable member 300 may be concentrated in the same location.

Specifically, the first slide member 310 and/or the second slide member 320 are correspondingly rotatably connected to an end of the connect rod 330. That is, at least one of the first slide member 310 and the second slide member 320 is rotatably connected to the connect rod 330. This allows the first slide member 310 and the second slide member 320 to slide more freely within the corresponding slide grooves, and the stress between the connect rod 330 and the slide member is very low, making the connection between the connect rod 330 and the slide member less prone to breakage, thus helping to ensure the structural stability of the movable member 300.

Specifically, two first slide members 310, two connect rods 330, two slide grooves 110 and two slide grooves 120 are correspondingly provided; one first slide member 310 is correspondingly connected to one first slide groove 110; both ends of the second slide member 320 are respectively connected to one second slide groove 120; one connect rod 330 is correspondingly connected to one end of one first slide member 310 and the second slide member 320; two first slide members 310 are spaced apart to allow an electrical connector 600 between the temple 20 and the frame 10 to pass through. That is, the movable member 300 engages with two side walls of the first bracket 100 on opposite sides, and the first slide member 310 and the second slide member 320 are connected by two connect rods 330. This can improve the structural stability of the movable member 300 and the engagement stability between the movable member 300 and the first bracket 100. Based on this, the first sliders 310 is configured as two spaced-apart components, providing a line passage space for the electrical connector 600 between the temple 20 and the frame 10. This line passage space remains stable even after the temple 20 is folded, ensuring that the electrical connector 600 is not compressed at the connection point of the temple 20, thus contributing to the stability of the electrical connection and signal transmission between the frame 10 and the temple 20.

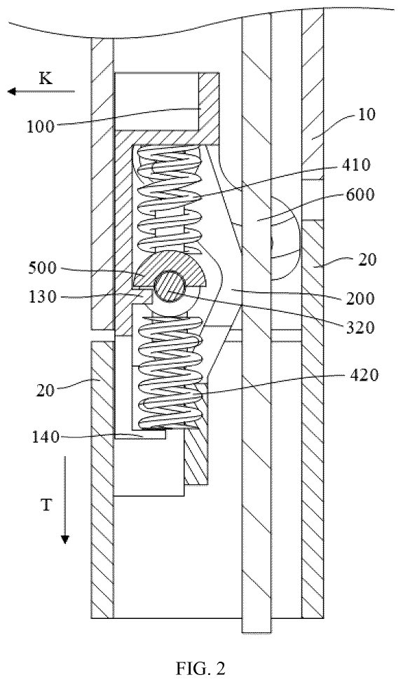

Further, in this embodiment, as shown in FIG. 2 and FIG. 5, the first bracket 100 includes a limit protrusion 130, and the first elastic member 410 is configured to abut against the limit protrusion 130 in the open position; when the second bracket 200 is folded outward from the open position, the second bracket 200 is configured to drive the second slide member 320 to press against the first elastic member 410 away from the limit protrusion 130; and when the second bracket 200 is folded inward from the open position, the second bracket 200 is configured to drive the second slide member 320 away from the first elastic member 410. Understandably, the limit protrusion 130 plays a limiting role on the first elastic member 410 in the distribution direction of the first elastic member 410 and the second slide member 320. Without loss of generality, the first elastic member 410 is configured as a compression spring. In the open position, one end of the first elastic member 410 simultaneously abuts against the limit protrusion 130 and the second slide member 320, while the other end of the first elastic member 410 abuts against the second bracket 200. As the second bracket 200 gradually folds outward from the open position, the second slide member 320 moves towards the side where the first elastic member 410 is located, thereby pressing against the first elastic member 410, causing the first elastic member 410 to gradually compress, and the elastic potential energy of the first elastic member 410 to gradually accumulate. Understandably, the greater the outward angle of the temple 20, the greater the risk of the head-mounted display device falling off. This embodiment provides a greater clamping force by the first elastic member 410, which can effectively ensure the wearing stability of the head-mounted display device. Furthermore, after the temple 20 is folded outwards, if no external force is applied, the first elastic member 410 will release its elastic potential energy, causing the second bracket 200 to return to the open position, and the head-mounted display device will then no longer maintain the outward-folded posture of the temple 200. When the second bracket 200 folds inwards from the open position, the second slide member 320 moves in the opposite direction, gradually moving away from the first elastic member 410, thus decoupling the first elastic member 410 from the second bracket 200, meaning the second bracket 200 will not be subjected to the force of the first elastic member 410.

In this embodiment, in the open position, the limit protrusion 130 limits the first elastic member 410, so that the first elastic member 410 can have a certain amount of compression even in the open position. Thus, when the outward folding amplitude of the second bracket 200 is small, the second bracket 200 can receive a relatively large elastic force from the first elastic member 410, thereby providing the temple 20 with sufficient clamping force. Certainly, in other embodiments, it can be that, in the open position, the first elastic member 410 may be in its natural stat. Thus, when the second bracket 200 is folded inward, the second slide member 320 can also separate from the first elastic member 410.

Furthermore, in this embodiment, as shown in FIG. 2, FIG. 3 and FIG. 5, the temple connection structure further includes an installation member 500, the installation member 500 is provided between the first elastic member 410 and the second slide member 320, the first elastic member 410 is installed at the installation member 500 and the installation member 500 is configured to abut against the limit protrusion 130 in the open position. Understandably, when the second bracket 200 is in the open position, the installation member 500 will also abut against the second slide member 320. Thus, the first elastic member 410 can indirectly abut against the limit protrusion 130 and the second slide member 320 via the installation member 500. When the second bracket 200 folds outward from the open position, the second slide member 320 indirectly presses against the first elastic member 410 by pushing against the installation member 500. In this embodiment, the installation member 500 provides a stable installation environment for the first elastic member 410, making the first elastic member 410 less prone to displacement. Certainly, in other embodiments, it can be that, the end of the first elastic member 410 can directly abut against the second slide member 320 and the limit protrusion 130.

Specifically, a cross-section of the installation member 500 is arc-shaped cross-section protruding away from the second slide member 320, and the second slide member 320 is detachably engaged with the installation member 500 in the open position. That is, the outer wall surface of the second slide member 320 and the installation member 500 that abuts against each other is an arc-shaped shape, which can increase the force-bearing surface area of both, reduce the pressure between them, and improve the uniformity of force distribution, thus ensuring the stability of the abutment between the second slide member 320 and the installation member 500. Certainly, in other embodiments, it can be that, the installation member 500 and the second slide member 320 may engage by surfaces of other shapes, or an elastic pad may be provided on any surface of the installation member 500 or the second slide member 320 that abuts against each other, so as to provide a cushioning effect.

Specifically, an installation protrusion 510 is provided to protrude from the installation member 500, and the first elastic member 410 is sleeved on the installation protrusion 510. In this way, the installation member 500 can provides a stable mounting for the first elastic member 410, ensuring that the first elastic member 410 does not easily detach from the installation member 500, and thus remains stably positioned between the first bracket 100 and the movable member 300. Furthermore, one or more first elastic members 410 can be provided, with the number of installation protrusions corresponding to the number of first elastic members 410. The end of the second elastic member 420 away from the installation member 500 directly abuts against the wall of the first bracket 100. Certainly, in other embodiments, it can be that, the installation member 500 may have a recessed installation hole, and the end of the first elastic member 410 is accommodated within the installation hole.

Further, in this embodiment, as shown in FIG. 3, the first slide groove 110 is arc-shaped groove, and the second slide groove 120 is linear-typed groove. In this way specifically, when the second bracket 200 rotates relative to the first bracket 100, the first slide member 310 moves within the arc-shaped first slide groove 110, and can follow the second bracket 200 well. The second slide groove 120 is linear, which simplifies its manufacturing. Simultaneously, the second slide member 320 slides within the second slide groove 120, ensuring that the second slide member 320 follows the first slide member 310. In this embodiment, the first slide member 310 and the second slide member 320 slide within the aforementioned shapes of the first slide groove 110 and the second slide groove 120, respectively, and the movement of the movable member 300 will resemble the movement of a crank-slider mechanism. Furthermore, a length direction of the second slide groove 120 is parallel to an axial direction of the first elastic member 410, and the second slide groove 120 is opposite to the first elastic member 410 in a width direction. Understandably, the second slide member 320 will slide within the second slide groove 120 along the length direction of the second slide groove 120. In this embodiment, the axis of the first elastic member 410 will coincide with or approximately coincide with the axis of symmetry of the second slide groove 120, so that the direction of the force exerted by the second slide member 320 on the first elastic member 410 can be on or approximately on the same straight line as the elastic force of the first elastic member 410. The second slide member 320 can more effectively resist the first elastic member 410. Furthermore, after compression, the first elastic member 410 has high coaxiality of the various forces it receives, making it less likely for the first elastic member 410 to deviate radially, which is beneficial to ensuring the installation stability of the first elastic member 410. Certainly, in other embodiments, the first slide groove 110 and the second slide groove 120 can be configured with other shapes, and the first slide groove 110 and the second slide groove 120 can be groove structures of the same shape type but with different extending directions.

Furthermore, as shown in FIG. 2, in this embodiment, the temple connection structure further includes a second elastic member 420, the second elastic member 420 is connected between the movable member 300 and the second bracket 200, and an elastic deformation of the second elastic member 420 is configured to first increase and then decrease during a process of the bracket switching from a folded position to the open position. That is, at an intermediate position between the folded position and the open position (referred to as the maximum elastic position for convenience in the following description), the elastic force on the second bracket 200 is the greatest, while the elastic force on the elastic member at the folded position or the open position is less than the elastic force on it at this intermediate position. In this way, under the action of the second elastic member 420, the temple 20 can maintain its current state when not subjected to external force in both the folded state and open state, preventing the temple 20 from opening and closing on its own. Furthermore, when the elastic deformation of the second elastic member 420 reaches its maximum position, if the temple 20 has an initial velocity in the folding direction or opening direction, under the action of the second elastic member 420, the temple 20 can still fold or open correspondingly even without subsequent force, achieving a slingshot effect, and improving the ease of opening or folding the temple 20. Without loss of generality, in both the open position and folded position, the second elastic member 420 is in a natural state, reaching its maximum elastic position when the opening angle of the temple 20 relative to the frame 10 is approximately 45 degrees. The second elastic member 420 can be a tension spring or a compression spring, or can be an elastic body such as a leaf spring, disc spring, torsion spring, variable diameter spring, or air compression spring.

Furthermore, in this embodiment, referring to FIG. 5 to FIG. 9, a minimum distance between the first slide groove 110 and the second slide groove 120 is a distance between a first position 103 of the first slide groove 110 and a second position of the second slide groove 120, and a length of the connect rod 330 is greater than the minimum distance; the first position 103 is provided between both ends of the first slide groove 110, and the first slide member 310 is respectively provided at both sides of the first position 103 in the open position and the folded position; and the second position is provided at one end of the second slide groove 120, and the other end of the second slide groove 120 is configured to extend away from the first position 103, and the second elastic member 420 is configured to abut against a side of the slide member opposite to the second position.

For ease of description, the two ends of the first slide groove 110 are referred to as the first end 101 and the second end 102, respectively; the two ends of the second slide groove 120 are referred to as the third end 121 and the fourth end 122, respectively; the first position 103 of the first slide groove 110 is located between the first end 101 and the second end 102; and the second position of the second slide groove 120 is located at the third end 121. Furthermore, it should be noted that “a slide member is closer to certain end of the corresponding slide groove” refers to relative to the other end of the slide groove, that is, if the distance between a slide member and certain end of the corresponding slide groove is less than the distance between the slide member and the other end, then the slide member is said to be closer to certain end.

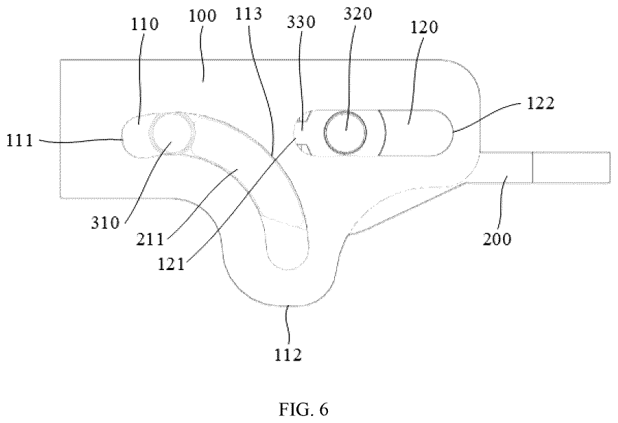

In this embodiment, as shown in FIG. 5 and FIG. 6, when the second bracket 200 is in the open position, the first slide member 310 is located between the first end 101 and the first position 103, while the second slide member 320 is positioned close to the third end 121, with a certain gap between the second slide member 320 and the third end 121.

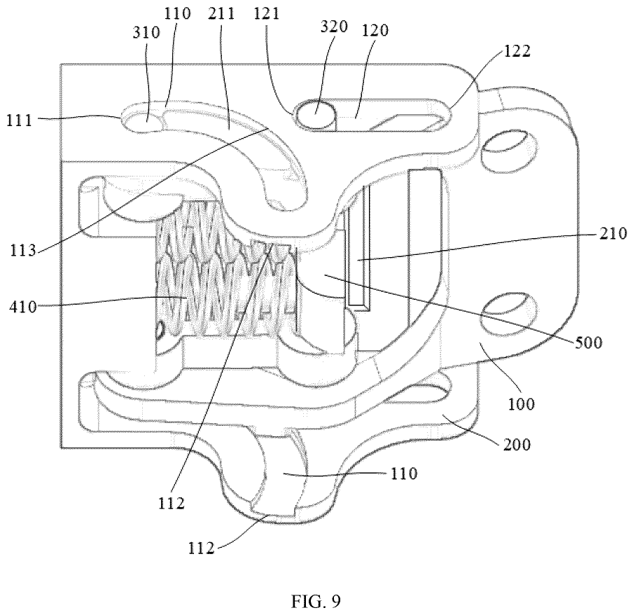

When the second bracket 200 is folded outward from the open position, the first slide member 310 slides towards the first end 101, and the second slide member 320 is driven to move towards the third end 121, thereby pressing against the first elastic member 410, thereby providing a clamping force to the temple 20 by the elastic force of the first elastic member 410. Without loss of generality, as shown in FIG. 9, when the second bracket 200 reaches its maximum outward folding position, the first slide member 310 can abut against the end wall of the first end 101, and the second slide member 320 can correspondingly abut against the end wall of the third end 121, providing positioning function and limiting disengagement function.

Referring to FIG. 6 to FIG. 8, when the second bracket 200 folds inward from the open position, the first slide member 310 will slide towards the second end 102. Before the first slide member 310 reaches the first position 103, the second slide member 320 will be pushed and slide towards the fourth end 122. The second slide member 320 disengages from the support of the first elastic member 410 and begins to press against the second elastic member 420, causing the elastic deformation of the second elastic member 420 to gradually increase. When the first slider 310 reaches the first position 103, the second slider 320 reaches the position closest to the fourth end 122. The second slider 320 can abut against the end wall of the fourth end 122. At this time, the elastic deformation of the second elastic member 420 reaches its maximum, and the second bracket 200 also reaches its maximum elastic position. As the first slide member 310 continues to slide from the first position 103 towards the second end 102, the second slide member 320 is pulled and slides in the opposite direction towards the third end 121. At this time, the resistance of the second slide member 320 to the second elastic member 420 weakens, and the second elastic member 420 gradually recovers its deformation until the temple 20 is fully folded; when the second bracket 200 is in the folded position, the first slide member 310 will move to the position closest to the second end 102, and the first slider 310 can reach the position of the second end 102.

In this way, relying on the relative positional relationship between the first slide groove 110 and the second slide groove 120 in this embodiment, the first elastic member 410 can effectively provide clamping force when the temple 20 is folded outwards and provide a spring-like effect when the temple 20 is folded inwards.

Furthermore, a length direction of the second slide groove 120 is parallel to an axial direction of the first elastic member 420, and the second slide groove 120 is opposite to the first elastic member 420 in a width direction. In this way, the axis of the second elastic member 420 will coincide with or approximately coincide with the axis of symmetry of the second slide groove 120, ensuring that the direction of the force exerted by the second slide member 320 on the second elastic member 420 is on or approximately on the same straight line as the elastic force of the second elastic member 420, so that the second slide member 320 can more effectively press against the second elastic member 420. Moreover, after compression, the second elastic member 420 experiences high coaxiality of the various forces, making it less prone to radial displacement and thus contributing to the installation stability of the second elastic member 420. Specifically, the first elastic member 410 and the second elastic member 420 are distributed on opposite sides of the second slide member 320 along the length of the second slide groove 120. The first bracket 100 corresponds to the second elastic member 420 and is provided with an abutment protrusion 140. The second elastic member 420 is accommodated between the abutment protrusion 140 and the second slide member 320. The end of the second elastic member 420 can be connected to the abutment protrusion 140 by an interlocking method. It can be that the first bracket 100 is provided with an extension arm, with the abutment protrusion 140 located at the end of the extension arm, and the temple 20 is provided with a clearance groove corresponding to the extension arm. It further can be that the end of the temple 20 can be positioned corresponding to the abutment protrusion 140. In both cases, interference from the first bracket 100 can be avoided during the rotation of the temple 20.

Furthermore, in this embodiment, the second bracket 200 is provided with a slide protrusion 211 and is rotatably connected to the first slide member 310, and the slide protrusion 211 is configured to avoid the first slide member 310 and slidably connected to the first slide groove 110, to cause a center of a circle of the first slide groove 110 to be a rotation center of the second bracket 200 relative to the first bracket 100. Specifically, the second slide groove 120 is distributed on the side near the temple 20, and the first slide groove 110 is arc-shaped and protrudes toward the second slide groove 120. The temple 20 rotates relative to the frame 10, causing the slide protrusion 211 to slide along the first slide groove 110. This allows the second bracket 200 to rotate around the center of a circle of the first slide groove 110. The slide protrusion 211 and the first slide member 310 avoid each other, allowing them to slide back and forth within the first slide groove 110. The rotational cooperation between the second bracket 200 and the first slide member 310 effectively counteracts changes in their relative positions. Certainly, in other embodiments, it can be that the second bracket 200 is rotatably connected to the first bracket 100 via a pivot.

Furthermore, in this embodiment, the slide protrusion 211 is configured as an arc shape adapted to the first slide groove 110, an end of the first slide groove 110 is provided with an avoidance notch 104, and a portion of the slide protrusion 211 is configured to extend out from the avoidance notch 104 when the second bracket 200 is in a folded position. That is, after the temple 20 is folded into place, a portion of the slide protrusion 211 extends outside the first slide groove 110, while the remaining portion remains within the first slide groove 110. In this way, on the one hand, it can prevent the slide protrusion 211 from dislodging from the first slide groove 110; on the other hand, it can block the avoidance notch 104, preventing the first slide member 310 from dislodging from the avoidance notch 104.

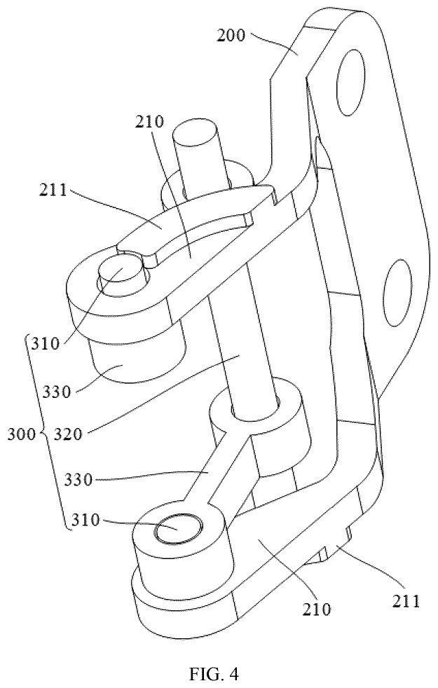

Further, in this embodiment, as shown in FIG. 3 and FIG. 4, the second bracket 200 includes two support arms 210 spaced apart, the second bracket 200 is rotatably connected to the first slide member 310 by the support arm 210, the two support arms 210 are configured to extend into the first bracket 100, and the slide protrusion 211 is provided at opposite sides of the two support arms 210; the first bracket 100 is correspondingly provided with two first slide grooves 110, and one slide protrusion 211 is correspondingly slidably connected to one first slide groove 110. Specifically, one support arm 210 is correspondingly rotatably connected to one first slide member 310, and both support arms 210 can respectively cooperate with the two first slide grooves 110 to improve the rotational stability of the second bracket 200. The spacing between the two support arms 210 does not interfere with the passage of the electrical connector 600 between the frame 10 and the temple 20, in conjunction with the gap between the two first slide members 310. In this way, the temple connection structure of this embodiment can provide a larger bending radius for the electrical connector 600, reducing the bending risk of the electrical connector 600, and improving the bending life of the head-mounted display device.

The present application further proposes a head-mounted display device, including a frame, temples, and the aforementioned temple connection structure. The specific structure of the temple connection structure is as described in the above embodiments. Since this head-mounted display device adopts all the technical solutions of all the above embodiments, it possesses at least all the beneficial effects brought about by the technical solutions of the above embodiments, which will not be elaborated further here. The temples are mounted on the frame via the temple connection structure.

Although some embodiments of the present application have been described, those skilled in the art, upon learning the basic inventive concept, can make other changes and modifications to these embodiments. Therefore, the appended claims are intended to be interpreted as including the embodiments as well as all changes and modifications falling within the scope of the present application.

The above embodiments are only some embodiments of the present application, and are not intended to limit the scope of the present application. Under the inventive concept of the present application, any equivalent structure or equivalent process transformation made by using the description and accompanying drawings of the present application, or directly or indirectly applied in other related technical fields, is included within the scope of the present application.

What is claimed is:

1. A temple connection structure for connecting a temple and a frame, comprising:
a first bracket and a second bracket rotatably connected to the first bracket, wherein the first bracket is configured to fix the frame, and the second bracket is configured to fix the temple;
a movable member movably installed at the first bracket and connected to the second bracket; and
a first elastic member provided between the first bracket and the movable member, and detachably provided from the movable member,
wherein when the second bracket is folded inward from an open position, the elastic member is configured to separate from the movable member; and
when the second bracket is folded outward from the open position, both ends of the first elastic member is configured to abut against the movable member and the first bracket respectively, and the second bracket is configured to receive an elastic force transmitted through the movable member from the elastic member, thereby providing a clamping force for the temple.

2. The temple connection structure according to claim 1, wherein the movable member comprises a connect rod and a first slide member and a second slide member connected via the connect rod; the first bracket comprises a first slide groove and a second slide groove; the first slide member is slidably connected to the first slide groove, and the second slide member is slidably connected to the second slide groove; the second bracket is connected to the first slide member, and the first elastic member is provided between the first bracket and the second slide member.

3. The temple connection structure according to claim 2, wherein the first bracket comprises a limit protrusion, and the first elastic member is configured to abut against the limit protrusion in the open position;
when the second bracket is folded outward from the open position, the second bracket is configured to drive the second slide member to press against the first elastic member away from the limit protrusion; and
when the second bracket is folded inward from the open position, the second bracket is configured to drive the second slide member away from the first elastic member.

4. The temple connection structure according to claim 3, further comprising an installation member, wherein the installation member is provided between the first elastic member and the second slide member, the first elastic member is installed at the installation member and the installation member is configured to abut against the limit protrusion in the open position.

5. The temple connection structure according to claim 4, wherein a cross-section of the installation member is arc-shaped cross-section protruding away from the second slide member, and the second slide member is detachably engaged with the installation member in the open position; and/or
an installation protrusion is provided to protrude from the installation member, and the first elastic member is sleeved on the installation protrusion.

6. The temple connection structure according to claim 2, wherein the first slide groove is arc-shaped groove, and the second slide groove is linear-typed groove.

7. The temple connection structure according to claim 6, further comprising a second elastic member, wherein the second elastic member is connected between the movable member and the second bracket, and an elastic deformation of the second elastic member first increases and then decreases during a process of the bracket switching from a folded position to the open position.

8. The temple connection structure according to claim 7, wherein a minimum distance between the first slide groove and the second slide groove is a distance between a first position of the first slide groove and a second position of the second slide groove, and a length of the connect rod is greater than the minimum distance;
the first position is provided between both ends of the first slide groove, and the first slide member is respectively provided at both sides of the first position in the open position and the folded position; and
the second position is provided at one end of the second slide groove, and the other end of the second slide groove is configured to extend away from the first position, and the second elastic member is configured to abut against a side of the slide member opposite to the second position.

9. The temple connection structure according to claim 8, wherein a length direction of the second slide groove is parallel to an axial direction of the first elastic member, and the second slide groove is opposite to the first elastic member in a width direction; and/or
the length direction of the second slide groove is parallel to an axial direction of the second elastic member, and the second slide groove is opposite to the second elastic member in the width direction.

10. The temple connection structure according to claim 6, wherein the second bracket is provided with a slide protrusion and is rotatably connected to the first slide member, and the slide protrusion is configured to avoid the first slide member and slidably connected to the first slide groove, to cause a center of a circle of the first slide groove to be a rotation center of the second bracket relative to the first bracket.

11. The temple connection structure according to claim 10, wherein the slide protrusion is configured as an arc shape adapted to the first slide groove, an end of the first slide groove is provided with an avoidance notch, and a portion of the slide protrusion is configured to extend out from the avoidance notch when the second bracket is in a folded position; and/or
the second bracket comprises two support arms spaced apart, the second bracket is rotatably connected to the first slide member by the support arm, the two support arms are configured to extend into the first bracket, and the slide protrusion is provided at opposite sides of the two support arms; the first bracket is correspondingly provided with two first slide grooves, and one slide protrusion is correspondingly slidably connected to the first slide groove.

12. The temple connection structure according to claim 2, wherein two first slide members, two connect rods, two first slide grooves, and two second slide grooves are correspondingly provided; one first slide member is correspondingly connected to one first slide groove; both ends of the second slide member are respectively connected to one second slide groove; one connect rod is correspondingly connected to one end of one first slide member and the second slide member; two first slide members are spaced apart to allow an electrical connector between the temple and the frame to pass through; and/or
the first slide member and/or the second slide member are correspondingly rotatably connected to an end of the connect rod.

13. A head-mounted display device, comprising a frame, temples, and the temple connection structure according to claim 1, wherein the temples are installed on the frame via the temple connection structure.
